(19) United States
(12) Patent Application Publication
(10) Pub. No.: US 2024/0231487 A1
(43) Pub. Date: Jul. 11, 2024

(54) Method and apparatus for unlocking a device or an application based on gaze tracking

(71) Applicant: Intel Corporation, Santa Clara, CA (US)

(72) Inventor: He XU, Beijing (CN)

(21) Appl. No.: 18/614,775

(22) Filed: Mar. 25, 2024

(30) Foreign Application Priority Data
Aug. 21, 2023 (WO) PCT/CN2023/113975

(51) Int. Cl. G06F 3/01; G06V 10/25; G06V 10/44

(52) U.S. Cl. CPC G06F 3/013; G06V 10/25; G06V 10/44

(57) ABSTRACT

A method and apparatus for unlocking a device or an application on the device based on gaze tracking. An image randomly selected from a set of images. Each image in the set of images includes a plurality of feature points and a sequence of feature points is pre-defined for each image. The selected image is presented to a user. A trajectory of gaze points of the user on the selected image presented to the user is determined. It is then determined whether the trajectory of gaze points of the user matches the pre-defined sequence of feature points on the selected image. The device or the application on the device is unlocked if the trajectory of gaze points of the user matches the pre-defined sequence of feature points on the selected image.

### BACKGROUND

User devices and software applications may require secure verification before being used or accessed by a user. Various unlocking methods have been developed and used for unlocking user devices and software applications.

One method is using a password. Password is the most commonly used method of unlocking electronic devices such as a mobile phone. The user enters a combination of letters, numbers, and symbols to access/unlock the device. Another method is pattern unlocking. This method involves drawing a specific pattern on a grid of dots to unlock the device. Another method is fingerprint unlocking. This method uses a fingerprint scanner to authenticate the user's identity and grant access to the device. Another method is facial recognition unlocking. This method uses the camera installed in the device to scan the user's face and authenticate the identity. Another way is eye gaze movement tracking unlocking. This method tracks eye gaze movements trajectory of the user and determine whether it is consistent with a pre-configured one, which may be a personal identification number (PIN)/password or a fixed trajectory.

Password and pattern unlock methods are often observable by unauthorized individuals who do not possess an authorization to use/control the device or application, which will make shoulder-surfing attacks that peek at the user from behind work. The use of face recognition and verification are becoming increasingly vulnerable to presentation attack (PA) techniques, thereby increasing its riskiness. In addition, the first three unlocking methods are not friendly to disabled people.

### BRIEF DESCRIPTION OF THE FIGURES

Some examples of apparatuses and/or methods will be described in the following by way of example only, and with reference to the accompanying figures, in which

FIGS. 1A and 1B are a block diagram of an example apparatus for unlocking a device or an application on the device based on gaze tracking;

FIG. 2 is a flow diagram of an example process for unlocking a device or an application on the device based on gaze tracking;

FIGS. 3A and 3B show a set of two images as an example;

FIGS. 4A and 4B show car images with an example sequence of feature points;

FIGS. 5A and 5B show an expected gaze trajectory of feature point sequence for the image of FIGS. 4A an 4B, respectively;

FIGS. 6A and 6B show bounding boxes for the feature points of the car image;

FIG. 7 is a flow diagram of an example process for the unlocking a device or an application;

FIG. 8 is a block diagram of an electronic apparatus incorporating at least one electronic assembly and/or method described herein;

FIG. 9 illustrates a computing device in accordance with one implementation of the invention; and

FIG. 10 is included to show an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Examples are disclosed herein for a novel method and apparatus for unlocking a device or an application (or a specific function of an application) on the device utilizing eye gaze tracking technology. The example schemes disclosed herein can defend against a wide variety of unlocking attacks while making unlocking much easier for the rightful users. The example schemes can also be used by people with carpal tunnel problems or any disabled people.

In examples, a set of images are pre-selected by a user or a system. The set of images may be any images, for example images of pets, cars, humans (e.g., favorite movie stars), objects, or any images that may serve as wallpaper background. Each image has feature points. For example, an image of a car has feature points of a front wheel, a rear wheel, a left rear-view mirror, a right rear-view mirror, a front left light, a front right light, or the like. The set of images include multiple different images having common feature points. For example, if the set of images include a plurality of images of a car, all images of the car in the set may have the common feature points of a front wheel, a rear wheel, a left rear-view mirror, a right rear-view mirror, a front left light, and a front right light. The common feature points of the car images may be more or less than those listed.

The user predefines a sequence (order) of feature points on the image for unlocking a device or application (or a specific function of the application) on the device. For example, in case of car image, the user may define the sequence (order) of feature points as a front left light to a front wheel to a real wheel to a left rear-view mirror.

When unlocking a device or application (or a function of the application) is requested, the system selects an image from the set of images randomly and presents the selected image to the user (the person who wants to unlock the device or application (or a function of the application)). The system then determines the eye gaze trajectory of the user on the image and compares the determined eye gaze trajectory to the predefined sequence of feature points on the image. If they match, the system unlocks the device or application/function. If they do not match, the system indicates unlocking failure.

The feature points on the image may be determined by object recognition algorithms. Since the positions of the feature points on different images are different and an image is randomly selected among the set of images to be presented to the user each time, the eye gaze movement required for unlocking the device or application for the image presented to the user is not fixed (i.e., different each time). This dynamic feature provides strong robustness and secretive nature, making it more resistant to various types of attacks.

Enterprises are presently implementing initiatives in the augmented reality/virtual reality (AR/VR) domain, aiming to develop and introduce smart glasses and wearable AR/VR devices, etc. Such devices normally incorporate advanced eye tracking capabilities, enabling users to interact with the device via gaze tracking. In examples disclosed herein, such eye gaze tracking capability may be used for unlocking the devices or applications to enhance the levels of randomness, security, and privacy in comparison to conventional unlocking methods.

In essence, the example methods disclosed herein provide an unlocking method using object detection using a random data set. The unlocking method disclosed herein may be used in conjunction with other unlocking methods, such as mouse random trajectory unlocking for PC, touch point random trajectory unlocking for mobile devices, etc.

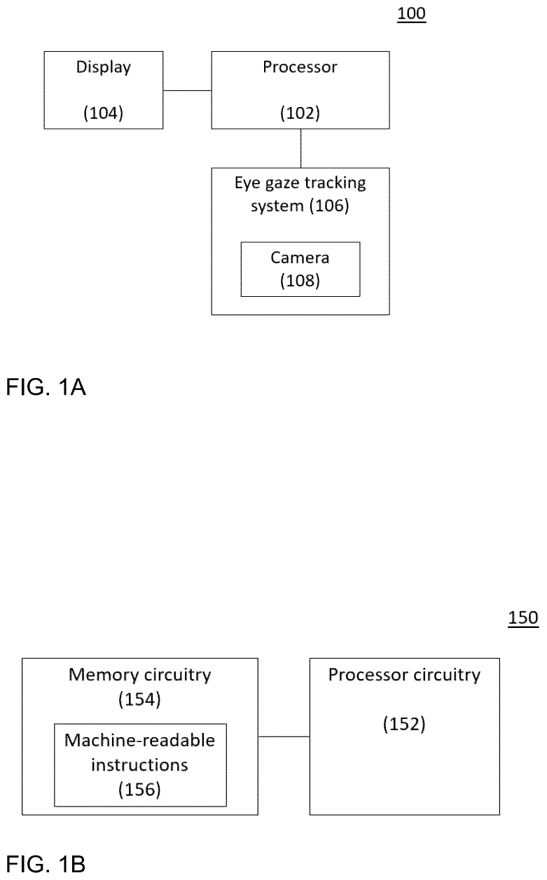

FIG. 1A is a block diagram of an example apparatus 100 for unlocking a device or an application (or a specific function of an application) on the device based on gaze tracking. The device may be any electronic device that may be required to unlock before use or access. For example, the device may be a mobile phone, a tablet, a personal computer, an augmented reality (AR) device, a virtual reality (VR) device, a wearable device, an Internet-of-Thing device, or the like. The example schemes disclosed herein are applicable to unlock an application running on the device or a specific function of the application. Hereafter, the term “application” will be used to include a specific function of the application as well.

The apparatus 100 includes a processor 102, a display 104, and an eye gaze tracking system 106. The display 104 is configured to display an image. Any conventional display may be used. The eye gaze tracking system 106 is configured to determine a trajectory of gaze points of a user on the image on the display 104. The eye gaze tracking system 106 includes a camera (108) for detecting the gaze points of the user on the image presented on the display. Any conventional eye gaze tracking systems/methods may be used for detecting and determining the eye gaze trajectory of the user. There are also several open-source gaze tracking methods/systems available. In practical applications, any suitable approach may be selected based on the specific usage scenarios.

The processor 102 is configured to select an image randomly from a set of images. Selecting randomly means that the selection lacks a definite plan, purpose, or pattern. One image is chosen from the set of images by chance rather than according to a plan, purpose, or pattern. Selecting randomly includes selecting pseudo-randomly. Pseudo-random means generating by some deterministic process, but it qualifies the predetermined statistical test for randomness. The set of images are pre-selected by a user or a system. The set of images may be any images, for example images of pets, cars, humans, objects, etc. Each image has feature points. For example, an image of a car has feature points of a front wheel, a rear wheel, a left rear-view mirror, a right rear-view mirror, a front left light, a front right light, or the like. An image of a dog or a cat has feature points of eyes, ears, a nose, a mouth, legs, etc. All or some of the images in the set include common feature points.

The user predefines a sequence (order) of feature points on the image (from the starting feature point to zero, one or more than on intermediate feature point to the last feature point) for unlocking a device or application on the device. For example, in case of car image, the user may define the sequence (order) of feature points as a front left light to a front wheel to a real wheel to a left rear-view mirror. The processor 102 is configured to present the selected image to the user on the display 104 and determine whether the trajectory of gaze points of the user matches the pre-defined sequence of feature points on the image. The processor 102 is configured to unlock the device or the application on the device if the trajectory of gaze points of the user matches the pre-defined sequence of feature points on the image, and otherwise indicate unlocking failure.

In some examples, the processor 102 may be configured to define a pixel block surrounding each feature point on the selected image as a bounding box and determine the trajectory of gaze points of the user by detecting a bounding box in which a gaze point of the user is located.

The determination whether the trajectory of gaze points of the user matches the pre-defined sequence of feature points on the image may be performed iteratively for each feature point. The processor 102 may be configured to obtain an i-th gaze point, wherein i is an integer ranging from 1 to N, and N is the number of feature points in the pre-defined sequence of feature points of the selected image. The processor 102 may be configured to determine whether the i-th gaze point is located in an i-th bounding box. The processor 102 may be configured to indicate unlocking failure if the i-th gaze point is not located in the i-th bounding box and determine that the trajectory of gaze points of the user matches the pre-defined sequence of feature points on the selected image if all gaze points are located in corresponding bounding boxes.

The processor 102 may be configured to indicate unlocking failure if a predetermined time period passes before a gaze point for the last bounding box in the sequence of feature points of the selected image is obtained. The predetermined time period may be set based on usage scenario. For example, when there are a large number of feature points in the picture, the user needs to concentrate more to complete the unlocking, and a longer time period may be allowed. If the number of feature points is small, the unlocking task is easier to complete, and the corresponding time period can be shortened appropriately.

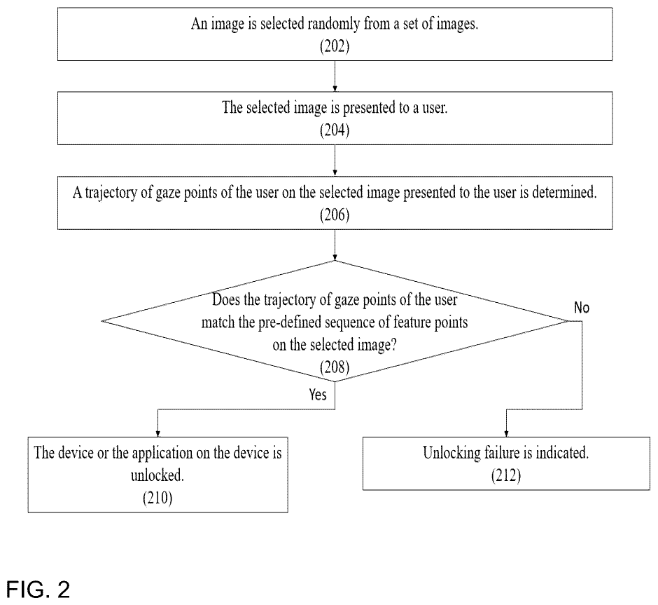

FIG. 2 is a flow diagram of an example process for unlocking a device or an application on the device based on gaze tracking. An image is selected randomly from a set of images (202). The set of images are preselected by the user or system. Each image in the set of images includes a plurality of feature points and a sequence of feature points is pre-defined for the images. The selected image is presented to a user (204). A trajectory of gaze points of the user on the selected image presented to the user is determined (206). It is then determined whether the trajectory of gaze points of the user matches the pre-defined sequence of feature points on the selected image (208). The device or the application on the device is unlocked if the trajectory of gaze points of the user matches the pre-defined sequence of feature points on the selected image (210). If the trajectory of gaze points of the user does not match the pre-defined sequence of feature points on the selected image, unlocking failure may be indicated (212).

FIG. 1B is a block diagram of an example apparatus 150 for unlocking a device or an application or a specific function of an application on the device based on gaze tracking. The apparatus 150 includes processor circuitry 152, memory circuitry 154, and machine-readable instructions 156 stored in the memory circuitry 154. The processor circuitry 152 is to execute the machine-readable instructions 156 to select an image randomly from a set of images, wherein each image in the set of images includes a plurality of feature points and a sequence of feature points is pre-defined for each image, present the selected image to a user, determine a trajectory of gaze points of the user on the selected image presented to the user, determine whether the trajectory of gaze points of the user matches the pre-defined sequence of feature points on the selected image, and unlock a device or an application on the device if the trajectory of gaze points of the user matches the pre-defined sequence of feature points on the selected image.

The device may be any electronic device, for example a mobile phone, a tablet, a personal computer, an augmented reality (AR) device, a virtual reality (VR) device, a wearable device, or an Internet-of-Thing device, etc. The set of images include any images, e.g., a car, a pet, a human, or an object, etc.

In some examples, the processor circuitry 152 may be configured to define a pixel block surrounding each feature point on the selected image as a bounding box and determine the trajectory of gaze points of the user by detecting a bounding box in which a gaze point of the user is located.

In some examples, the processor circuitry 152 may be configured to obtain an i-th gaze point, wherein i is an integer ranging from 1 to N, and N is the number of feature points in the pre-defined sequence of feature points of the selected image and determine whether the i-th gaze point is located in an i-th bounding box. The processor circuitry may be configured to indicate unlocking failure if the i-th gaze point is not located in the i-th bounding box and determine that the trajectory of gaze points of the user matches the pre-defined sequence of feature points on the selected image if all gaze points are located in corresponding bounding boxes.

In some examples, the processor circuitry may be configured to indicate unlocking failure if a predetermined time period passes before a gaze point for a last bounding box in the sequence of feature points of the selected image is obtained. The predetermined time period is set based on usage scenario.

The unlocking method in accordance with the examples disclosed herein is touch-free. It is more robust because it is nearly invisible to others and could resist various attacks. It is also friendly to users with carpal tunnel problems or disability. Compared to the conventional eye gaze movement tracking methods which uses a fixed trajectory for unlocking, the unlocking method disclosed herein is more random, robust, and concealed because the eye gaze trajectory for unlocking the device/application is not fixed but varies each time since a different image is selected randomly each time.

Example methods are explained in detail hereafter.

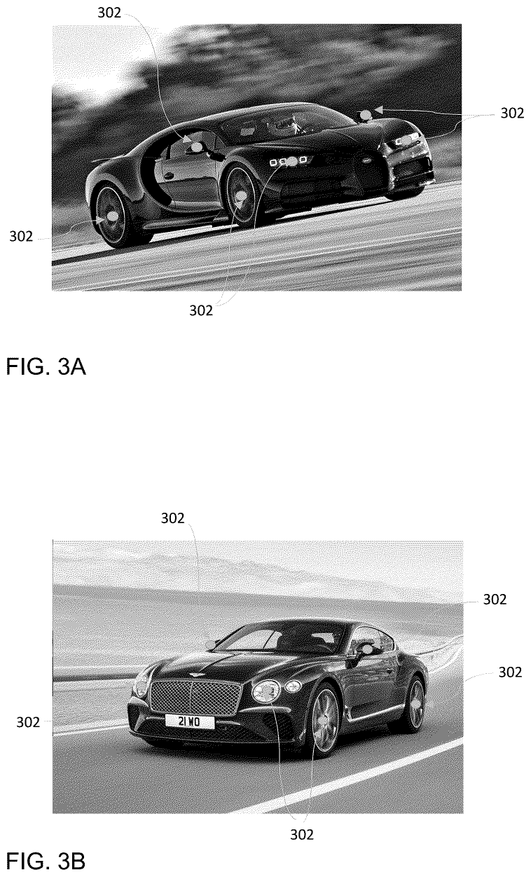

In examples, a user may select a set of images. Alternatively, the set of images may be selected by the system. The set of images may be any images, for example pets, cars, humans, objects, etc. FIGS. 3A and 3B show a set of two images as an example (images of a car in this example). The set of images of a car may be images of the same car or different cars. Each image has a plurality of feature points. FIGS. 3A and 3B show example feature points 302 of a car (indicated as dots). For example, the feature points 302 of a car may be a front wheel, a rear wheel, a left rear-view mirror, a right rear-view mirror, a left front light, a right front light, etc. of the car. All or some of the images in the set of images have common feature points. In the example shown in FIGS. 3A and 3B, both images include six (6) common feature points of a front wheel, a rear wheel, a left rear-view mirror, a right rear-view mirror, a left front light, a right front light.

The user pre-defines a sequence of feature points of an image. The sequence is defined by the meaning of the feature points, not by the position of the feature points. FIGS.

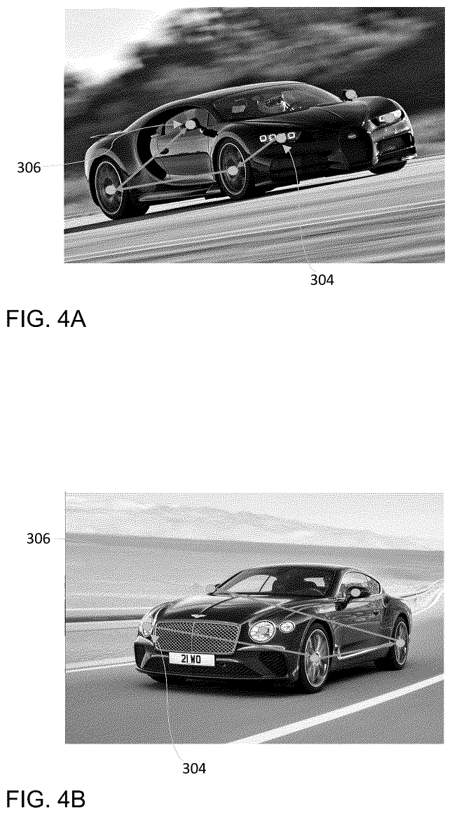

4A and 4B show car images with an example sequence of feature points starting from the first feature point 304 to the last feature point 306. In the example shown in FIGS. 4A and 4B, the user defines the sequence of feature points of a car image as: a left front light→a front wheel→a rear wheel→a left front light. This is merely an example, and a different sequence of feature points may be selected. As shown in FIGS. 4A and 4B, the predefined sequence of feature points of a car image is same for both images of FIGS. 4A and 4B even though the car images in FIGS. 4A and 4B are different.

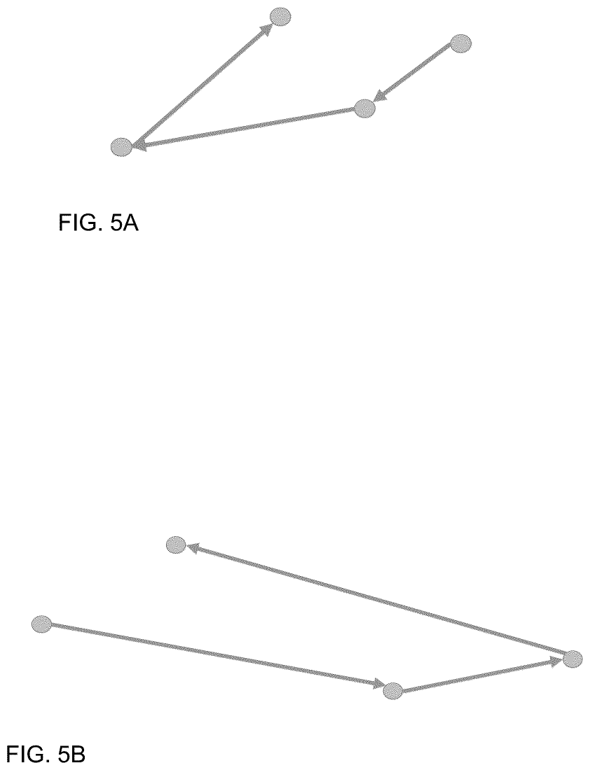

The system selects an image from the set of images randomly and presents the selected image to the user (e.g., displays on a screen). The system then determines the eye gaze trajectory of the user on the image presented to the user. FIG. 5A shows an expected gaze trajectory of feature point sequence for the image of FIG. 4A, and FIG. 5B shows an expected gaze trajectory of feature point sequence for the image of FIG. 4B. As depicted in FIGS. 5A and 5B, the eye gaze trajectories for the two different images to unlock the device/application vary, despite following the same sequence of feature points. Therefore, the example schemes disclosed herein exhibit randomness and secret for a particular image set, while remaining highly robust and secure against attacks, including attempts to track the user's gaze or eye movement by intruders.

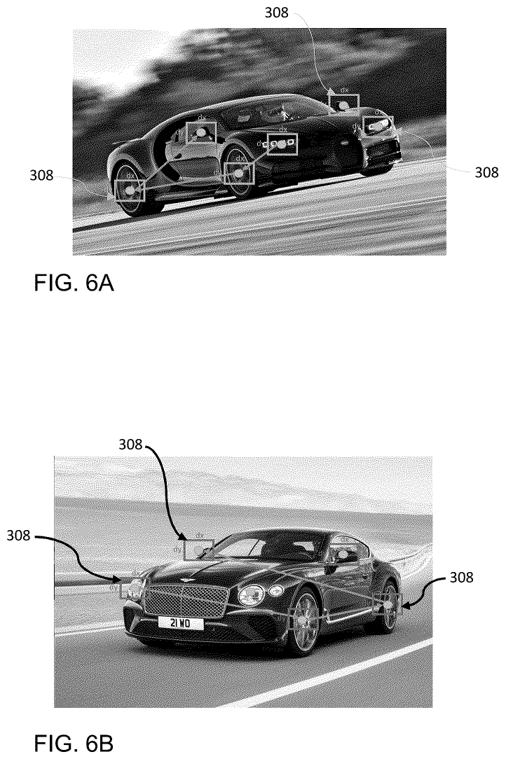

Considering the potential error associated with the gaze tracking technique, in example schemes, a pixel block for each feature point may be used as a bounding box. FIGS. 6A and 6B show bounding boxes 308 for the feature points of the car image. The feature points may be centered in the bounding box 308. As an example, object recognition algorithms may provide a bounding box to locate a recognized object. In example systems, the bounding boxes identified by the object recognition algorithm may be used for gaze tracking. Each feature point may be regarded as the center pixel of the corresponding bounding box. The system detects the gaze point of the user and considers that the gaze point for a feature point is valid when the gaze point is located within the bounding box for the corresponding feature point.

The system may determine whether the user's gaze points follow the pre-defined sequence (order) within a preconfigured period of time (e.g., k seconds). If it is determined that the user's gaze points follow the pre-defined sequence within a preconfigured period of time, unlocking is completed. The preconfigured time length (e.g., k seconds) may be selected according to usage scenarios. If it is determined that the user's gaze points do not follow the pre-defined sequence within the preconfigured period of time, unlocking fails and the system may reset.

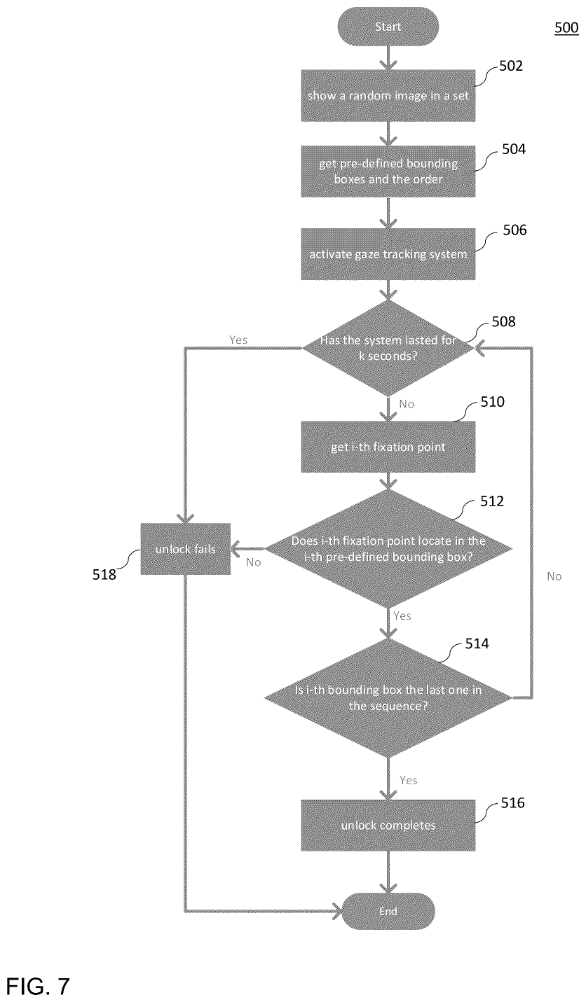

FIG. 7 is a flow diagram of an example process 500 for the unlocking a device or an application. The system determines whether the user's gaze points follow the pre-defined sequence (order) of the image. The system may determine iteratively whether the gaze points of the user match the pre-defined sequence of feature points of the selected image.

The system chooses an image randomly from a set of images and display the selected image on screen for the user (502). The set of images are preselected by the user or system. The system gets the bounding boxes for the feature points of the selected image and the order of the feature points (504). The order of feature points is pre-defined by the user.

The system activates the gaze tracking system (506). Any conventional gaze tracking system may be used. The system may determine whether the system has been running for the preconfigured period of time (e.g., k seconds) since the process 500 started (e.g., since presentation of the selected image) (508). If so, the unlocking fails (518). If not, the system obtains the i-th gaze point of the user (510) and determines whether the i-th gaze point is located in the i-th bounding box in the sequence (512). If it is determined that the i-th gaze point is not located in the i-th bounding box, the unlocking fails (518). If it is determined that the i-th gaze point is located in the i-th bounding box, it is further determined whether the current i-th bounding box is the last one in the sequence (514). If not, the process goes to step 508 for the next iteration. If so, the unlocking completes (516) and the system unlocks the device or application.

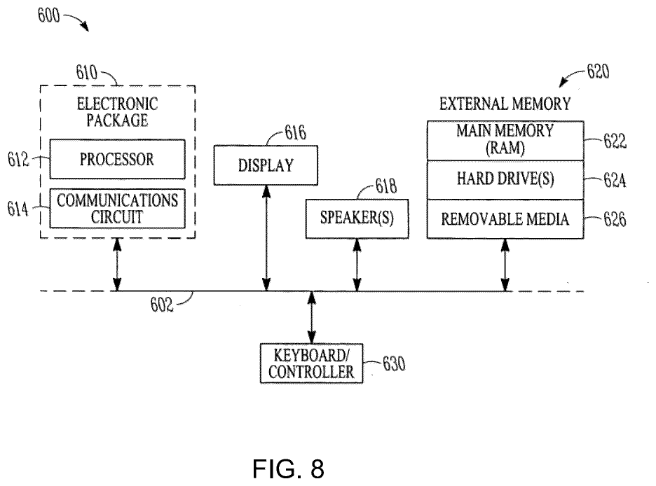

FIG. 8 is a block diagram of an electronic apparatus 600 incorporating at least one electronic assembly and/or method described herein. Electronic apparatus 600 is-merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

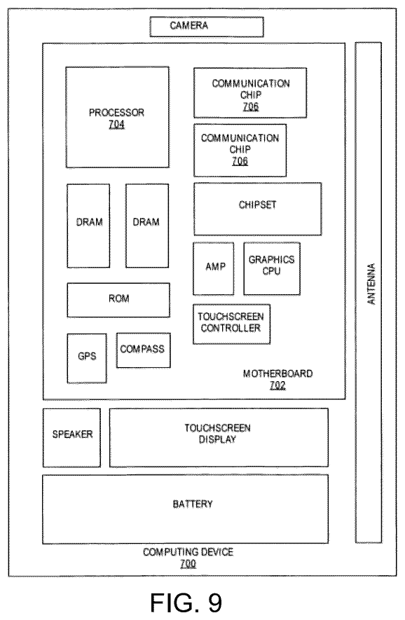

FIG. 9 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non- solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based P0P package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based P0P package that that includes a mold layer directly contacting a substrate, in accordance with implementations of the invention.

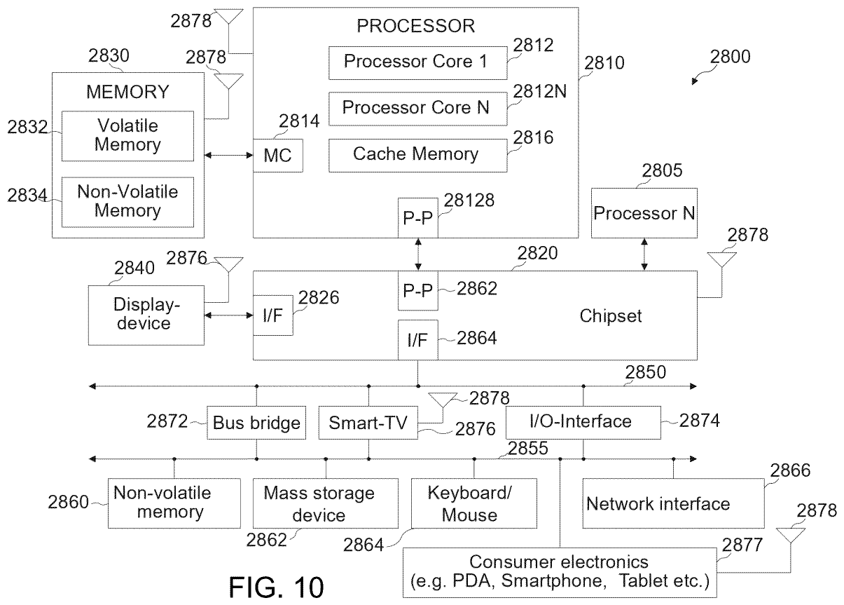

FIG. 10 is included to show an example of a higher level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 28 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to an apparatus comprising memory circuitry, machine-readable instructions stored in the memory circuitry, and processor circuitry to execute the machine-readable instructions to: select an image randomly from a set of images, wherein each image in the set of images includes a plurality of feature points and a sequence of feature points is pre-defined for each image; present the selected image to a user; determine a trajectory of gaze points of the user on the selected image presented to the user; determine whether the trajectory of gaze points of the user matches the pre-defined sequence of feature points on the selected image; and unlock a device or an application on the device if the trajectory of gaze points of the user matches the pre-defined sequence of feature points on the selected image.

Another example, (e.g., example 2) relates to a previously described example (e.g., example 1), wherein the processor circuitry is to define a pixel block surrounding each feature point on the selected image as a bounding box and determine the trajectory of gaze points of the user by detecting a bounding box in which a gaze point of the user is located.

Another example, (e.g., example 3) relates to a previously described example (e.g., example 2), wherein the processor circuitry is to obtain an i-th gaze point, wherein i is an integer ranging from 1 to N, and N is the number of feature points in the pre-defined sequence of feature points of the selected image; and determine whether the i-th gaze point is located in an i-th bounding box. The processor circuitry is to indicate unlocking failure if the i-th gaze point is not located in the i-th bounding box and determine that the trajectory of gaze points of the user matches the pre-defined sequence of feature points on the selected image if all gaze points are located in corresponding bounding boxes.

Another example, (e.g., example 4) relates to a previously described example (e.g., example 3), wherein the processor circuitry is to indicate unlocking failure if a predetermined time period passes before a gaze point for a last bounding box in the sequence of feature points of the selected image is obtained.

Another example, (e.g., example 5) relates to a previously described example (e.g., example 4), wherein the predetermined time period is set based on usage scenario.

Another example, (e.g., example 6) relates to a previously described example (e.g., any one of examples 1-5), wherein the device is one of a mobile phone, a tablet, a personal computer, an augmented reality (AR) device, a virtual reality (VR) device, a wearable device, or an Internet-of-Thing device.

Another example, (e.g., example 7) relates to a previously described example (e.g., any one of examples 1-6), wherein the set of images include images of at least one of a car, a pet, a human, or an object.

Another example, (e.g., example 8) relates to a method for unlocking a device or an application on the device based on gaze tracking, comprising: selecting an image randomly from a set of images, wherein each image in the set of images includes a plurality of feature points and a sequence of feature points is pre-defined for each image; presenting the selected image to a user; determining a trajectory of gaze points of the user on the selected image that is presented to the user; determining whether the trajectory of gaze points of the user matches the pre-defined sequence of feature points on the selected image; and unlocking the device or the application on the device if the trajectory of gaze points of the user matches the pre-defined sequence of feature points on the selected image.

Another example, (e.g., example 9) relates to a previously described example (e.g., example 8), wherein a pixel block surrounding each feature point on the selected image is defined as a bounding box, and the trajectory of gaze points of the user is determined by detecting a bounding box in which a gaze point of the user is located.

Another example, (e.g., example 10) relates to a previously described example (e.g., example 9), wherein whether the trajectory of gaze points of the user matches the pre-defined sequence of feature points of the selected image is determined by an iterative process, wherein each iteration comprises: obtaining an i-th gaze point, wherein i is an integer ranging from 1 to N, and N is the number of feature points in the pre-defined sequence of feature points of the selected image; and determining whether the i-th gaze point is located in an i-th bounding box, wherein unlocking failure is indicated if the i-th gaze point is not located in the i-th bounding box and it is determined that the trajectory of gaze points of the user matches the pre-defined sequence of feature points on the selected image if all gaze points are located in corresponding bounding boxes.

Another example, (e.g., example 11) relates to a previously described example (e.g., example 10), wherein unlocking failure is indicated if a predetermined time period passes before a gaze point for a last bounding box in the sequence of feature points of the selected image is obtained.

Another example, (e.g., example 12) relates to a previously described example (e.g., example 11), wherein the predetermined time period is set based on usage scenario.

Another example, (e.g., example 13) relates to a previously described example (e.g., any one of examples 8-12), wherein the device is one of a mobile phone, a tablet, a personal computer, an augmented reality (AR) device, a virtual reality (VR) device, a wearable device, or an Internet-of-Thing device.

Another example, (e.g., example 14) relates to a previously described example (e.g., any one of examples 8-13), wherein the set of images include images of at least one of a car, a pet, a human, or an object.

Another example, (e.g., example 15) relates to an apparatus for unlocking a device or an application on the device based on gaze tracking, comprising: a display configured to display an image; an eye gaze tracking system configured to determine a trajectory of gaze points of a user on the image presented to the user; and a processor configured to select the image randomly from a set of images, wherein each image in the set of images includes a plurality of feature points and a sequence of feature points is pre-defined for each image, wherein the processor is further configured to present the selected image to a user using the display, determine whether the trajectory of gaze points of the user matches the pre-defined sequence of feature points on the selected image, and unlock the device or the application on the device if the trajectory of gaze points of the user matches the pre-defined sequence of feature points on the selected image.

Another example, (e.g., example 16) relates to a previously described example (e.g., example 15), wherein the processor is configured to define a pixel block surrounding each feature point on the selected image as a bounding box and determine the trajectory of gaze points of the user by detecting a bounding box in which a gaze point of the user is located.

Another example, (e.g., example 17) relates to a previously described example (e.g., example 16), wherein the processor is to: obtain an i-th gaze point, wherein i is an integer ranging from 1 to N, and N is the number of feature points in the pre-defined sequence of feature points of the selected image; and determine whether the i-th gaze point is located in an i-th bounding box, wherein the processor is to indicate unlocking failure if the i-th gaze point is not located in the i-th bounding box and determine that the trajectory of gaze points of the user matches the pre-defined sequence of feature points on the selected image if all gaze points are located in corresponding bounding boxes.

Another example, (e.g., example 18) relates to a previously described example (e.g., example 17), wherein the processor is to indicate unlocking failure if a predetermined time period passes before a gaze point for a last bounding box in the sequence of feature points of the selected image is obtained.

Another example, (e.g., example 19) relates to a previously described example (e.g., example 18), wherein the predetermined time period is set based on usage scenario.

Another example, (e.g., example 20) relates to a non-transitory machine-readable medium including code, when executed, to cause a machine to perform the method as in any one of examples 8-14.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may for instance, illustrate a high-level circuit diagram implementing the principles of the disclosure. Similarly, a flow chart, a flow diagram, a state transition diagram, a pseudo code, and the like may represent various processes, operations or steps, which may for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that - although a dependent claim may refer in the claims to a specific combination with one or more other claims - other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. An apparatus comprising:
memory circuitry;
machine-readable instructions stored in the memory circuitry; and
processor circuitry to execute the machine-readable instructions to:
select an image randomly from a set of images, wherein each image in the set of images includes a plurality of feature points and a sequence of feature points is pre-defined for each image;
present the selected image to a user;
determine a trajectory of gaze points of the user on the selected image presented to the user;
determine whether the trajectory of gaze points of the user matches the pre-defined sequence of feature points on the selected image; and
unlock a device or an application on the device if the trajectory of gaze points of the user matches the pre-defined sequence of feature points on the selected image.

2. The apparatus of claim 1, wherein the processor circuitry is to define a pixel block surrounding each feature point on the selected image as a bounding box and determine the trajectory of gaze points of the user by detecting a bounding box in which a gaze point of the user is located.

3. The apparatus of claim 2, wherein the processor circuitry is to:
obtain an i-th gaze point, wherein i is an integer ranging from 1 to N, and N is the number of feature points in the pre-defined sequence of feature points of the selected image; and
determine whether the i-th gaze point is located in an i-th bounding box,
wherein the processor circuitry is to indicate unlocking failure if the i-th gaze point is not located in the i-th bounding box and determine that the trajectory of gaze points of the user matches the pre-defined sequence of feature points on the selected image if all gaze points are located in corresponding bounding boxes.

4. The apparatus of claim 3, wherein the processor circuitry is to indicate unlocking failure if a predetermined time period passes before a gaze point for a last bounding box in the sequence of feature points of the selected image is obtained.

5. The apparatus of claim 4, wherein the predetermined time period is set based on usage scenario.

6. The apparatus of claim 1, wherein the device is one of a mobile phone, a tablet, a personal computer, an augmented reality (AR) device, a virtual reality (VR) device, a wearable device, or an Internet-of-Thing device.

7. The apparatus of claim 1, wherein the set of images include images of at least one of a car, a pet, a human, or an object.

8. A method for unlocking a device or an application on the device based on gaze tracking, comprising:
selecting an image randomly from a set of images, wherein each image in the set of images includes a plurality of feature points and a sequence of feature points is pre-defined for each image;
presenting the selected image to a user;
determining a trajectory of gaze points of the user on the selected image that is presented to the user;
determining whether the trajectory of gaze points of the user matches the pre-defined sequence of feature points on the selected image; and
unlocking the device or the application on the device if the trajectory of gaze points of the user matches the pre-defined sequence of feature points on the selected image.

9. The method of claim 8, wherein a pixel block surrounding each feature point on the selected image is defined as a bounding box, and the trajectory of gaze points of the user is determined by detecting a bounding box in which a gaze point of the user is located.

10. The method of claim 9, wherein whether the trajectory of gaze points of the user matches the pre-defined sequence of feature points of the selected image is determined by an iterative process, wherein each iteration comprises:
obtaining an i-th gaze point, wherein i is an integer ranging from 1 to N, and N is the number of feature points in the pre-defined sequence of feature points of the selected image; and
determining whether the i-th gaze point is located in an i-th bounding box,
wherein unlocking failure is indicated if the i-th gaze point is not located in the i-th bounding box and it is determined that the trajectory of gaze points of the user matches the pre-defined sequence of feature points on the selected image if all gaze points are located in corresponding bounding boxes.

11. The method of claim 10, wherein unlocking failure is indicated if a predetermined time period passes before a gaze point for a last bounding box in the sequence of feature points of the selected image is obtained.

12. The method of claim 11, wherein the predetermined time period is set based on usage scenario.

13. The method of claim 8, wherein the device is one of a mobile phone, a tablet, a personal computer, an augmented reality (AR) device, a virtual reality (VR) device, a wearable device, or an Internet-of-Thing device.

14. The method of claim 8, wherein the set of images include images of at least one of a car, a pet, a human, or an object.

15. An apparatus for unlocking a device or an application on the device based on gaze tracking, comprising:
a display configured to display an image;
an eye gaze tracking system configured to determine a trajectory of gaze points of a user on the image presented to the user; and
a processor configured to select the image randomly from a set of images, wherein each image in the set of images includes a plurality of feature points and a sequence of feature points is pre-defined for each image, wherein the processor is further configured to present the selected image to a user using the display, determine whether the trajectory of gaze points of the user matches the pre-defined sequence of feature points on the selected image, and unlock the device or the application on the device if the trajectory of gaze points of the user matches the pre-defined sequence of feature points on the selected image.

16. The apparatus of claim 15, wherein the processor is configured to define a pixel block surrounding each feature point on the selected image as a bounding box and determine the trajectory of gaze points of the user by detecting a bounding box in which a gaze point of the user is located.

17. The apparatus of claim 16, wherein the processor is to:
obtain an i-th gaze point, wherein i is an integer ranging from 1 to N, and N is the number of feature points in the pre-defined sequence of feature points of the selected image; and
determine whether the i-th gaze point is located in an i-th bounding box,
wherein the processor is to indicate unlocking failure if the i-th gaze point is not located in the i-th bounding box and determine that the trajectory of gaze points of the user matches the pre-defined sequence of feature points on the selected image if all gaze points are located in corresponding bounding boxes.

18. The apparatus of claim 17, wherein the processor is to indicate unlocking failure if a predetermined time period passes before a gaze point for a last bounding box in the sequence of feature points of the selected image is obtained.

19. The apparatus of claim 18, wherein the predetermined time period is set based on usage scenario.

20. A non-transitory machine-readable medium including code, when executed, to cause a machine to perform the method of claim 8.
